(19) United States
(12) Patent Application Publication
(10) Pub. No.: US 2024/0427314 A1
(43) Pub. Date: Dec. 26, 2024

(54) INDUSTRIAL MACHINE CONTROL SYSTEM

(71) Applicant: FANUC CORPORATION, Yamanashi (JP)

(72) Inventors: Hisateru ISHIWARI, Yamanashi (JP); Yuki INOUE, Yamanashi (JP)

(73) Assignee: FANUC CORPORATION, Yamanashi (JP)

(21) Appl. No.: 18/691,717

(22) PCT Filed: Sep. 30, 2021
(86) PCT No.: PCT/JP2021/036347

§ 371 Date: Mar. 13, 2024

(51) Int. Cl. G05B 19/4155

(52) U.S. Cl. CPC G05B 19/4155; G05B 2219/31449

(57) ABSTRACT

The present invention reproduces the state of a real device more accurately by using operation state data indicating the behavior of the real device. This industrial machine control system comprises: a real device comprising a control device for controlling an industrial machine; and a digital device for simulating the real device by software. The digital device comprises an input unit that inputs operation state data acquired by the real device to the digital device, and simulates the real device by the digital device using the operation state data input by the input unit.

### TECHNICAL FIELD

The present invention relates to an industrial machine control system.

### BACKGROUND ART

With regard to a real device including an industrial machine, and a control device and a drive device such as a motor and an amplifier that control and drive the industrial machine, a digital simulator in which each of the industrial machine, control device, the drive device, etc. is modeled based on each theoretical value has been conventionally developed.

The digital simulator generally has a structure in which each device is reproduced with software.

In this respect, there is known a technique capable of providing a high-quality engineering by creating and debugging software for operating a control device that controls a field device installed in a plant, providing a cloud for simulating an operating state of the control device according to a simulated input or an input to the control device and software, and debugging the software based on an operating result of the simulation and an output from the control device or a simulated input. For example, see Patent Document 1.

### CITATION LIST

### Patent Document

Patent Document 1: Japanese Unexamined Patent Application, Publication No. 2020-52812

### DISCLOSURE OF THE INVENTION

### Problems to be Solved by the Invention

A digital simulator such as that disclosed in Patent Document 1 simulates and emulates a real device including an industrial machine, and a control device and a drive device such as a motor and an amplifier that control and drive the industrial machine individually, but there is a limit to the simulation and emulation, and it is difficult to accurately reproduce the behavior of the real device.

This is caused by the elements of the real device that cannot be easily simulated by software, for example, delays between communications, mechanical losses, performance of the CPU (central processing unit), changes due to the surrounding environment, and the like.

Therefore, it is desired to reproduce the state of the real device more accurately by using the operation state data indicating the behavior of the real device.

### Means for Solving the Problems

One aspect of an industrial machine control system of the present disclosure provides an industrial machine control system including a real device including a control device configured to control an industrial machine and a digital device configured to simulate the real device with software. The digital device includes an input unit for inputting operation state data acquired in the real device to the digital device. The digital device simulates the real device with the operation state data input to the input unit.

### Effects of the Invention

According to one aspect, a more accurate state of the real device can be reproduced using the operating state data indicating the behavior of the real device.

### BRIEF DESCRIPTION OF THE DRAWINGS

FIG. 1 is a functional block diagram showing a functional configuration example of an industrial machine control system according to an embodiment;

FIG. 2 shows an operation example of the industrial machine control system when the operation of a ladder control device is reproduced using an actual signal processing speed;

FIG. 3A shows an example of an instruction of a ladder program;

FIG. 3B is an example of a timing chart of the instruction in FIG. 3A;

FIG. 4 shows an operation example of the industrial machine control system when the operation of a machine tool is reproduced using actual feedback amounts;

FIG. 5 shows an operation example of the industrial machine control system when the operation of the machine tool is reproduced using actual feedback amounts;

FIG. 6 shows an operation example of the industrial machine control system when a machining program is modified according to the actual CPU performance of a numerical control device;

FIG. 7 shows an example of a machining program for testing that measures BPTmin;

FIG. 8 shows an example of the relationship between the block length and BPT;

FIG. 9 shows an example of addition or deletion of command points of a machining program by a simulation execution unit;

FIG. 10 shows an operation example of the industrial machine control system when a machining program is modified based on the actual power consumption of the machine tool;

FIG. 11 shows an example of the relationship between the feed speed (or spindle rotation speed) and the power consumption;

FIG. 12 shows an example of the relationship between the feed speed (or spindle rotation speed) and the total power consumption;

FIG. 13 shows an operation example of the industrial machine control system when the occurrence of an overheat alarm is reproduced using the motor temperature of the machine tool; and

FIG. 14 shows an example of the relationship between the rotation time and the motor temperature for each rotation speed (or current).

### PREFERRED MODE FOR CARRYING OUT THE INVENTION

### <One Embodiment>

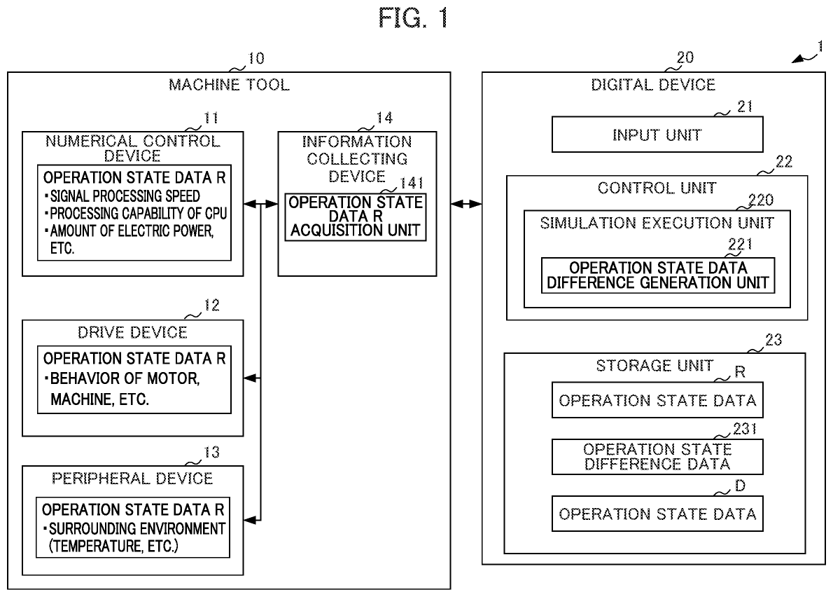

FIG. 1 is a functional block diagram showing a functional configuration example of an industrial machine control system according to an embodiment. Here, a machine tool is exemplified as an industrial machine, and a numerical control device is exemplified as a control device. The present invention is not limited to machine tools and numerical control devices, and can also be applied to industrial machines such as injection molding machines, industrial robots, and service robots, and robot control devices that control industrial robots and the like.

As shown in FIG. 1, an industrial machine control system 1 includes a machine tool 10 as a real device and a digital device 20.

The machine tool 10 and the digital device 20 may be directly connected to each other via a connection interface (not shown). The machine tool 10 and the digital device 20 may be connected to each other via a network (not shown) such as a LAN (local area network) or the Internet. In this case, the machine tool 10 and the digital device 20 are each provided with a communication unit (not shown) for communicating with each other through such a connection.

### <Machine Tool 10>

The machine tool 10 is a machine tool known to those skilled in the art, and includes a numerical control device 11 as a control device, a drive device 12, a peripheral device 13, and an information collecting device 14. The machine tool 10 operates based on an operation command of the numerical control device 11, which will be described later.

Each of the numerical control device 11, the drive device 12, the peripheral device 13, and the information collecting device 14 is included in the machine tool 10, but may be a device different from the machine tool 10.

The numerical control device 11 is a numerical control device known to those skilled in the art, and, for example, generates an operation command based on a machining program acquired from a CAD/CAM device or the like (not shown), and transmits the generated operation command to the machine tool 10. Thus, the numerical control device 11 controls the operation of the machine tool 10. When the machine tool 10 is a robot or the like, the numerical control device 11 may be a robot control device or the like.

While controlling the machine tool 10, the numerical control device 11 outputs information about the signal processing speed and the processing capability of the CPU and information about the amount of electric power and the like to the information collecting device 14, which will be described later, as operation state data R.

The drive device 12 drives a motor (not shown) for a spindle included in the machine tool 10 via an amplifier (not shown) included in the drive device 12 based on a command from the numerical control device 11. Specifically, the drive device 12 drives the motor (not shown) while feed backing, as a signal, information including the position and speed of the motor (not shown) detected by an encoder (not shown). The motor (not shown) can be applied to various motors used for a feed shaft and a spindle of a machine tool, an industrial machine, an arm of an industrial robot, and the like.

While driving the amplifier and the motor (not shown), the drive device 12 outputs information (e.g., speed, motor temperature, etc.) about the behavior of the motor (not shown) or machine to the information collecting device 14 (described later) as the operation state data R.

The peripheral device 13 is a belt conveyor or the like, and operates based on a command from the numerical control device 11. While operating, the peripheral device 13 outputs information on the surrounding environment such as temperature to the information collecting device 14 described later as the operation state data R.

The information collecting device 14 is, for example, a computer, and includes an operation state data R acquisition unit 141. The information collecting device 14 includes an arithmetic processing device such as a CPU. The information collecting device 14 includes an auxiliary storage device such as an HDD (hard disk drive) in which various control programs such as application software and an OS (operating system) are stored, and a main storage device such as a RAM (random access memory) in which data temporarily required for the arithmetic processing device to execute a program is stored.

Then, in the information collecting device 14, the arithmetic processing device reads application software and OS from the auxiliary storage device, and performs arithmetic processing based on the application software and OS while expanding the read application software and OS in the main storage device. Further, based on the arithmetic results, various hardware included in the information collecting device 14 is controlled. Thus, the functional blocks of the present embodiment are implemented. That is, the present embodiment can be implemented by cooperation of hardware and software.

The operation state data R acquisition unit 141 acquires the operation state data R output from each of the numerical control device 11, the drive device 12, and the peripheral device 13, and outputs the acquired operation state data R to the digital device 20 described later.

In the industrial machine control system 1 according to the present embodiment, the information collecting device 14 is placed in the machine tool 10, but may be placed in the digital device 20.

### <Digital Device 20>

The digital device 20 is, for example, a computer, and includes an input unit 21, a control unit 22, and a storage unit 23. The control unit 22 includes a simulation execution unit 220. The simulation execution unit 220 includes an operation state data difference generation unit 221.

The input unit 21 inputs the operation state data R acquired in the machine tool 10 as a real device to the digital device 20.

Specifically, for example, the input unit 21 inputs the operation state data R of each of the numerical control device 11, the drive device 12, and the peripheral device 13 of the machine tool 10 acquired by the information collecting device 14 of the machine tool 10 to the digital device 20.

The storage unit 23 is a RAM, an HDD, and the like, and stores the operation state data R, operation state difference data 231, and operation state data D.

As described above, the operation state data R is the operation state data R of each of the numerical control device 11, the drive device 12, and the peripheral device 13 of the machine tool 10 acquired by the information collecting device 14 of the machine tool 10.

The operation state difference data 231 is difference data between the operation state data R of each of the numerical control device 11, the drive device 12, and the peripheral device 13 and the operation state data D of each of the numerical control device 11, the drive device 12, and the peripheral device 13 simulated by the simulation execution unit 220 described later, calculated by the operation state data difference generation unit 221 described later.

The operation state data D is the operation state data D of each of the numerical control device 11, the drive device 12, and the peripheral device 13 that have been simulated (emulated) by the simulation execution unit 220 described later.

The control unit 22 includes a CPU, a ROM, a RAM, a CMOS (complementary metal-oxide-semiconductor) memory, and the like, which are configured to communicate with each other via a bus, and are known to those skilled in the art.

The CPU is a processor that controls the entire digital device 20. The CPU reads the system program and the application programs stored in the ROM via the bus, and controls the entire digital device 20 according to the system program and the application programs. Thereby, as shown in FIG. 1, the control unit 22 is configured to implement the function of the simulation execution unit 220. The simulation execution unit 220 is configured to implement the function of the operation state data difference generation unit 221. The RAM stores a variety of data such as temporary calculation data and display data. The CMOS memory is backed up by a battery (not shown), and is configured as a non-volatile memory in which a storage state is held even when the digital device 20 is turned off.

The simulation execution unit 220 executes a simulation for operating each of the numerical control device 11, the drive device 12, and the peripheral device 13 based on a machining program executed in the machine tool 10, and acquires the operation state data D indicating the operation and/or state of each of the numerical control device 11, the drive device 12, and the peripheral device 13. The simulation execution unit 220 stores the acquired operation state data D of each of the numerical control device 11, the drive device 12, and the peripheral device 13 in the storage unit 23.

The operation state data difference generation unit 221 generates the operation state difference data 231 by calculating the difference between the operation state data R and the operation state data D for each of the numerical control device 11, the drive device 12, and the peripheral device 13. The operation state data difference generation unit 221 stores the generated operation state difference data 231 of each of the numerical control device 11, the drive device 12, and the peripheral device 13 in the storage unit 23.

In the industrial machine control system 1 according to the present embodiment, the operation state data difference generation unit 221 is placed in the digital device 20, but may be placed in the information collecting device 14 of the machine tool 10, or may be placed in both the information collecting device 14 and the digital device 20. When the operation state data difference generation unit 221 is placed in the information collecting device 14, the digital device 20 may output the operation state data D of each of the numerical control device 11, the drive device 12, and the peripheral device 13 simulated by the simulation execution unit 220 to the information collecting device 14 of the machine tool 10.

Next, regarding the operation of the industrial machine control system 1, (A) a case where the operation of the machine tool 10 is reproduced using an actual signal processing speed, (B) a case where the operation of the machine tool 10 is reproduced using actual feedback amounts, (C) a case where the machining program is modified according to the actual CPU performance of the numerical control device 11, (D) a case where the machining program is modified based on the actual power consumption of the machine tool 10, and (E) a case where the occurrence of an overheat alarm is reproduced using the motor temperature of the machine tool 10 will be described.

(A) Regarding the Case Where the Operation of the Machine Tool 10 is Reproduced Using the Actual Signal Processing Speed

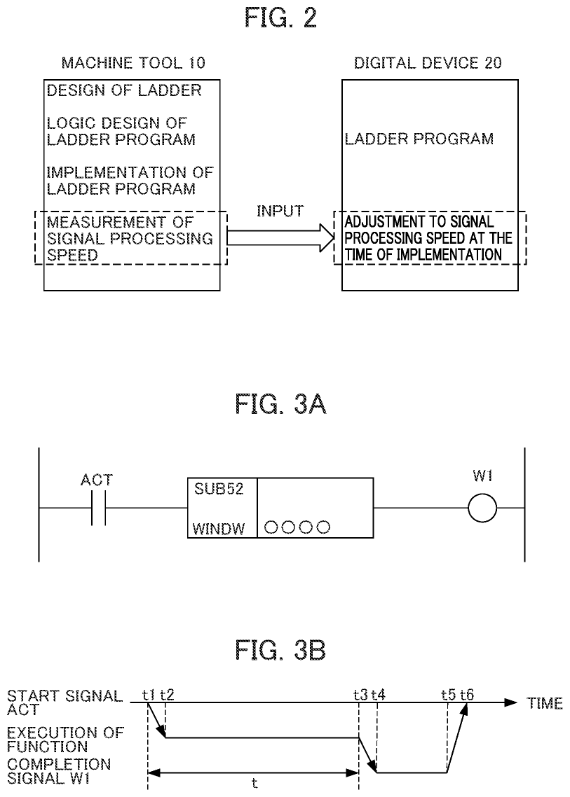

FIG. 2 shows an operation example of the industrial machine control system 1 when the operation of the ladder control device is reproduced using the actual signal processing speed.

As shown in FIG. 2, the numerical control device 11 of the machine tool 10 implements and executes a ladder program in the ladder control device (not shown) connected to the numerical control device 11, for example. The numerical control device 11 measures the signal processing speed while controlling the machine tool 10, and outputs information on the measured signal processing speed to the information collecting device 14 as the operation state data R. The information collecting device 14 outputs the operation state data R of the numerical control device 11 to the digital device 20. The digital device 20 adjusts the signal processing speed to that of the machine tool 10 at the time of implementation based on the signal processing speed contained in the operating state data R acquired from the machine tool 10, and simulates the ladder program.

Specifically, for example, when the ladder control device (not shown) executes each instruction of the ladder program, the numerical control device 11 measures the processing time of each instruction as a signal processing speed.

FIG. 3A shows an example of an instruction of the ladder program. FIG. 3B is an example of a timing chart of the instruction in FIG. 3A. The case of the instruction shown in FIG. 3A will be described, and the signal processing speed of other instructions are measured in the same manner as in the case of FIG. 3A.

For example, when the ladder control device (not shown) executes an instruction to write data to the numerical control device 11 shown in FIG. 3A, the numerical control device 11 measures a time t from a time t1 when the ladder control device (not shown) outputs an ACT signal for executing the instruction to a time t3 when the ladder control device (not shown) internally completes the processing of the function instruction as the processing time of the instruction. Since a time t4 to a time t6 during which a completion signal W1 is returned is the subsequent ladder execution period, the numerical control device 11 can acquire the accurate processing time of the ladder control device (not shown) by measuring the time t from the time t1 to the time t3.

The numerical control device 11 inputs the processing times of all instructions included in the ladder program as the signal processing speeds of the operation state data R to the digital device 20 via the information collecting device 14.

The digital device 20 corrects the processing time of the instruction of the ladder program in the digital device 20 according to the input processing time. Thus, the digital device 20 can execute the ladder program at the same timing as the machine tool 10.

In other words, conventionally, even if a simulator could reproduce the logic, it could not reproduce the actual processing speed (response speed), which could cause signal timing problems during implementation. The digital device 20 can accurately reproduce the signal processing speed by inputting it to the digital device 20.

(B) Regarding the Case Where the Operation of the Machine Tool 10 is Reproduced Using the Actual Feedback Amounts

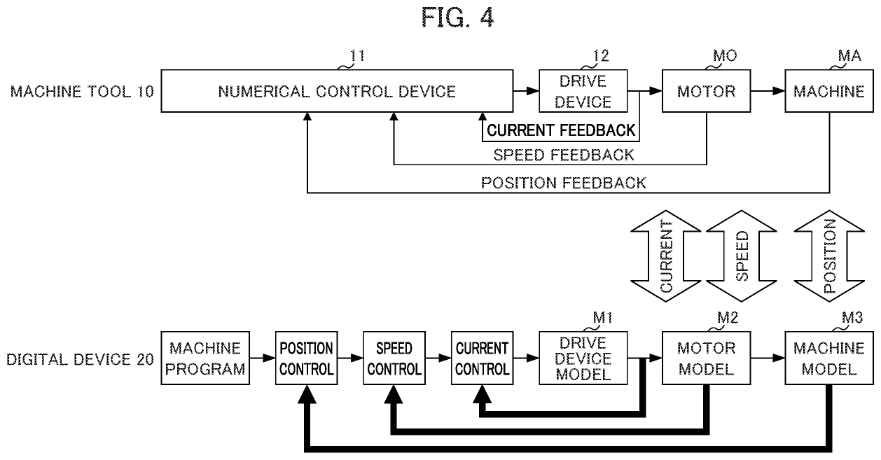

FIG. 4 shows an operation example of the industrial machine control system 1 when the operation of the machine tool 10 is reproduced using actual feedback amounts.

As shown in FIG. 4, the numerical control device 11 of the machine tool 10 executes the machining program to generate a position command for each block of the machining program and generate a speed command based on the generated position command. The numerical control device 11 calculates a position deviation from the generated position command and position feedback (feedback amount) indicating the actual position of a machine MA such as the spindle included in the machine tool 10, and corrects the position command using the calculated position deviation. The numerical control device 11 calculates a speed deviation from the generated speed command and speed feedback (feedback amount) indicating the actual speed of a motor MO driven by the drive device 12, and corrects the speed command using the calculated speed deviation. The numerical control device 11 outputs the corrected position command and speed command to the drive device 12.

The numerical control device 11 may generate a current command (torque command) by performing, for example, PI (proportional, integral) control on the obtained speed deviation. The numerical control device 11 may output, to the drive device 12, a current command corrected with a current deviation between the generated current command and current feedback (feedback amount) output from the drive device 12 to the motor MO.

The information collecting device 14 acquires the position feedback, the speed feedback, and the current feedback as the operation state data R along with the position command, the speed command, and the current command from the numerical control device 11. The information collecting device 14 outputs the acquired operation state data R of the numerical control device 11 to the digital device 20.

The simulation execution unit 220 of the digital device 20 executes simulation of the machine tool 10 based on the acquired operation state data R and the machining program.

Specifically, for example, the simulation execution unit 220 operates a drive device model M1 modeling the drive device 12, a motor model M2 modeling the motor MO, and a machine model M3 modeling the machine MA based on the machining program, and calculates the feedback amounts of current feedback from the drive device model M1, speed feedback from the motor model M2, and position feedback from the machine model M3. The simulation execution unit 220 respectively compares the feedback amounts of the current feedback, the speed feedback, and the position feedback included in the operation state data R acquired from the machine tool 10 with the calculated feedback amounts of the current feedback, the speed feedback, and the position feedback, and inputs the differences between the feedback amounts of the respective feedbacks, thereby simulating the position control, the speed control, and the current control.

Thus, the digital device 20 can perform accurate reproduction by inputting the differences in the feedback amounts between the machine tool 10 and the digital device 20 to the digital device 20, although it is difficult for conventional simulators to accurately match the actual behavior of motors and machines.

The drive device model M1 and the motor model M2 are created using a known method such as WO2020/003738. The machine model M3 is created using a known method such as “A Study on Low Frequency Vibration Suppression Control by Two-Mass System Model for Feed Axes of NC Machine Tools”, 2016, Vol. 82, No. 8, pp. 745-750, Journal of the Japan Society for Precision Engineering.

In the industrial machine control system 1 in FIG. 4, the differences in the feedback amounts between the machine tool 10 and the digital device 20 to the digital device 20 are input to the digital device 20, but the present invention is not limited thereto. For example, in the industrial machine control system 1, the feedback amounts of the current feedback, speed feedback, and position feedback to the numerical control device 11 included in the operation state data R acquired in the machine tool 10 may be directly input to the digital device 20.

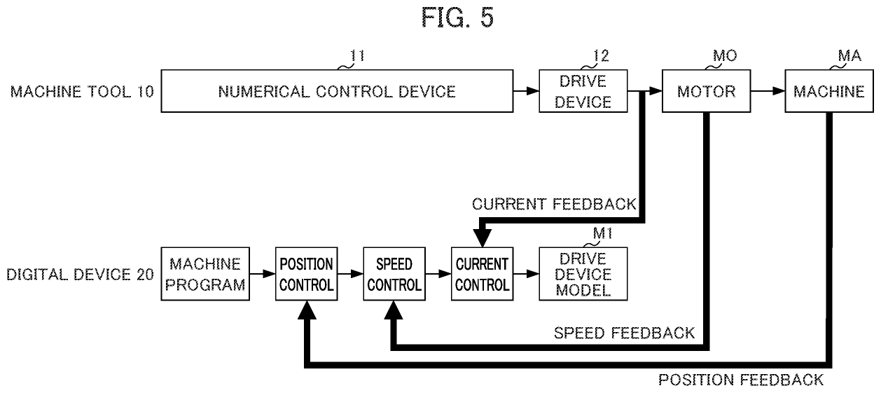

FIG. 5 shows an operation example of the industrial machine control system when the operation of the machine tool 10 is reproduced using actual feedback amounts. Note that elements having the same functions as those of the elements in FIG. 4 are denoted by the same reference numerals, and detailed descriptions thereof are omitted. In the digital device 20, the motor model M2 and the machine model M3 are omitted.

Thus, the industrial machine control system 1 allows more accurate reproduction by inputting the feedback amounts of the machine tool 10 to the digital device 20, although it is difficult for conventional simulators to accurately match the actual behavior of motors and machines.

(C) Regarding the Case Where the Machining Program is Modified According to the Actual CPU Performance of the Numerical Control Device 11

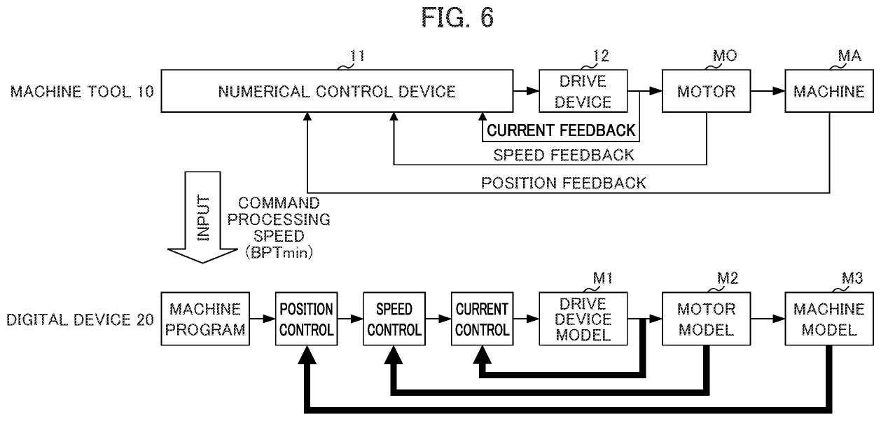

FIG. 6 shows an operation example of the industrial machine control system 1 when the machining program is modified according to the actual CPU performance of the numerical control device 11. Note that elements having the same functions as those of the elements in FIG. 4 are denoted by the same reference numerals, and detailed descriptions thereof are omitted.

As shown in FIG. 6, the numerical control device 11 measures BPTmin, which is a limit value (minimum value) of a command processing speed (for example, BPT: block processing time) of the numerical control device 11, as will be described later. The digital device 20 acquires the operation state data R including information indicating the relationship between the block length of the machining program and BPT in the numerical control device 11 and BPTmin via the information collecting device 14, and matches the BPTmin in the simulation with the BPTmin of the numerical control device 11. The digital device 20 executes simulation, determines the degree of margin depending on whether BPTmin is reached, and modifies the machining program so as to correspond to the BPTmin of the numerical control device 11 by adding/deleting command points of the machining program.

Specifically, for example, the numerical control device 11 operates the machine tool 10 by executing a machining program for testing in which the block length changes under a constant feed speed condition, measures the limit value (BPTmin) of BPT, and acquires the relationship (function) between the block length and the BPT.

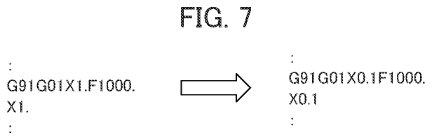

FIG. 7 shows an example of the machining program for testing that measures BPTmin. FIG. 7 shows one block of the machining program for testing.

As shown in FIG. 7, to acquire the relationship (function) between the block length and BPT, the numerical control device 11 reduces the block length of the machining program for testing until deceleration occurs by changing the block length at a predetermined ratio (for example, 1/10 or the like), and measures the minimum value of the block length.

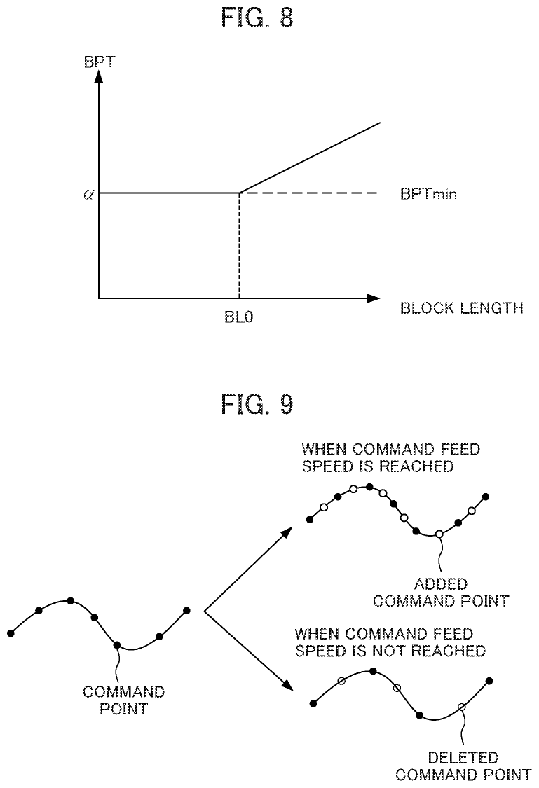

FIG. 8 shows an example of the relationship between the block length and BPT. BPT (s/block) is a block length (mm/block)/feed speed (mm/ms), and changes according to an index indicating the performance of the numerical control device 11 and the performance of the CPU included in the numerical control device 11. BPTmin is the minimum value of the block length/the command feed speed.

As shown in FIG. 8, BPT decreases as the block length decreases to the block length BL0. When the block length becomes the block length BL0 or less, BPT becomes a constant value “a”. That is, the minimum value “a” of BPT is the limit value and is BPTmin.

The information collecting device 14 outputs the operation state data R including the relationship (function) between the block length and BPT in FIG. 8 and BPTmin acquired by the numerical control device 11 to the digital device 20.

The simulation execution unit 220 of the digital device 20 matches the BPTmin when executing the machining program in the simulation with the BPTmin included in the operation state data R. In other words, although the limit value of the BPT in the simulation of the digital device 20 is smaller (the program can be processed finer and faster), the BPTmin in the simulation is matched with that of the machine tool 10.

The simulation execution unit 220 determines whether or not the command feed speed is reached (i.e., whether or not there is deceleration) when operating the machining program in the simulation, and modifies the machining program by adding or deleting command points of the machining program based on the determination result.

For example, the simulation execution unit 220 adds a command point to the machining program (reduces the block length) when the command feed speed is reached (there is no deceleration), and deletes a command point from the machining program (increases the block length) when the command feed speed is not reached (there is deceleration).

FIG. 9 shows an example of addition or deletion of command points of the machining program by the simulation execution unit 220.

As shown in the lower part of FIG. 9, when the command feed speed is not reached (there is deceleration), the simulation execution unit 220 deletes command points from the machining program, i.e., increases the block length so as to reach the command feed speed.

On the other hand, for example, when the command feed speed is reached at a block length of 0.1 mm in the original machining program, the simulation execution unit 220 performs the simulation again using a machining program in which the block length is changed to 0.05 mm, 0.01 mm, or the like, that is, command points are added. When there is no deceleration at a block length of 0.05 mm but there is deceleration at a block length of 0.01 mm, the simulation execution unit 220 modifies the machining program by adding command points so that the block length is 0.05 mm, as shown in the upper part of FIG. 9.

The digital device 20 transmits the modified machining program to the machine tool 10.

Thus, the digital device 20 can optimize the machining program according to the command processing capability of the numerical control device 11 by inputting the command processing capability (BPT processing capability) of the numerical control device 11 to the digital device 20, whereas conventional simulators do not consider the actual processing capability of numerical control.

(D) Regarding the Case Where the Machining Program is Modified Based on the Actual Power Consumption of the Machine Tool 10

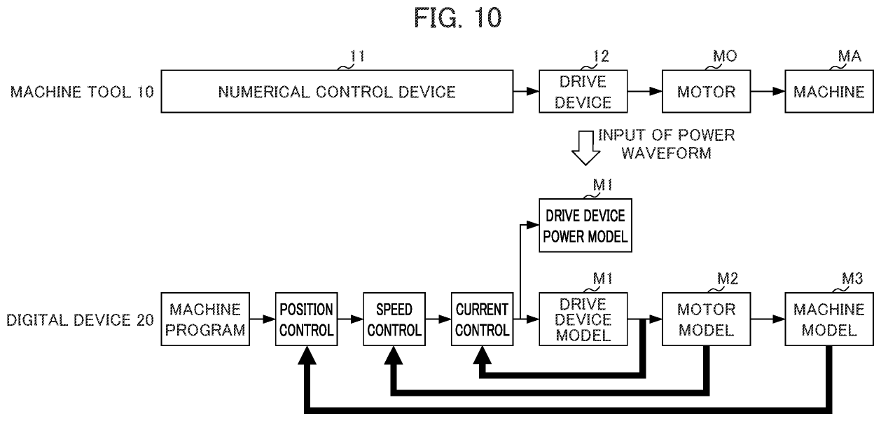

FIG. 10 shows an operation example of the industrial machine control system 1 when the machining program is modified based on the actual power consumption of the machine tool 10. Note that elements having the same functions as those of the elements in FIG. 4 are denoted by the same reference numerals, and detailed descriptions thereof are omitted. In FIG. 10, illustration of current feedback of the drive device 12, speed feedback of the motor MO, and position feedback of the machine MA is omitted.

As will be described later, the numerical control device 11 measures power consumption (instantaneous value for each speed) of the machine tool 10 according to the feed speed or the spindle rotation speed, and acquires the relationship (function) between the feed speed or the spindle rotation speed and the power consumption. The digital device 20 acquires the operation state data R including the relationship (function) between the speed or the spindle rotation speed and the power consumption measured by the numerical control device 11 via the information collecting device 14. The digital device 20 calculates the total power consumption in the machine tool 10 by integrating the power consumption during the operation of the machining program using the acquired relationship (function) between the speed or the spindle rotation speed and the power consumption as a drive device power model M4 in the simulation to be executed. The digital device 20 modifies the feed speed or the spindle rotation speed of the machining program that minimizes the total power consumption, including the machining time.

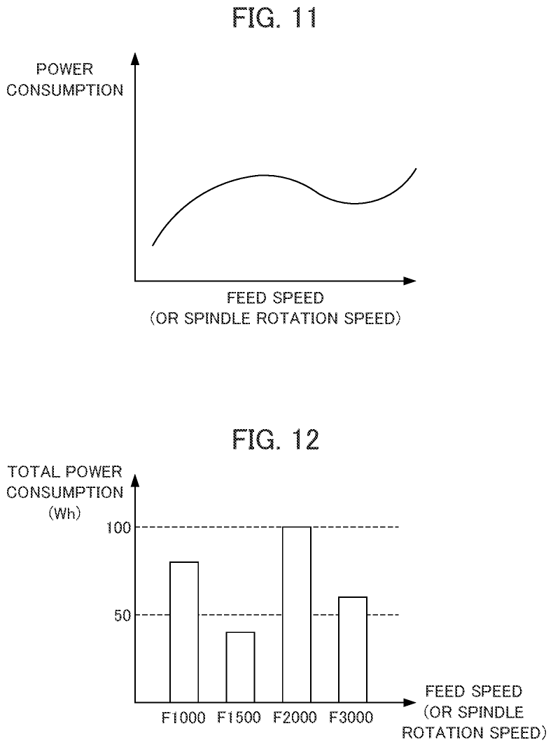

Specifically, for example, the numerical control device 11 operates the machine tool 10 by executing the machining program for testing in which the feed speed (or the spindle rotation speed) changes, measures instantaneous power consumption for each feed speed (or spindle rotation speed), and acquires the relationship (function) between the feed speed (or spindle rotation speed) and power consumption as shown in FIG. 11.

The information collecting device 14 outputs, to the digital device 20, the operation state data R including the relationship (function) between the feed speed (or spindle rotation speed) and power consumption shown in FIG. 11 acquired by the numerical control device 11.

In the simulation to be executed, the simulation execution unit 220 of the digital device 20 uses the relationship (function) between the feed speed (or the spindle rotation speed) and the power consumption included in the operation state data R as the drive device power model M4 to calculate and add the instantaneous power consumption when the machining program is operated at each feed speed (or spindle rotation speed) in the simulation, thereby calculating the total power consumption during the operation.

FIG. 12 shows an example of the relationship between the feed speed (or the spindle rotation speed) and the total power consumption.

As shown in FIG. 12, for example, when the original feed speed set in the machining program is F2000 [mm/min], the simulation execution unit 220 calculates the total power consumption as 100 Wh by simulation. Further, the simulation execution unit 220 calculates the total power consumption of 80 Wh, 40 Wh, and 60 Wh by simulation when the feed speed of the machining program is changed to F1000 [mm/min], F1500 [mm/min], and F3000 [mm/min], respectively.

Based on the simulation results, the simulation execution unit 220 modifies the machining program from a feed speed of F2000 [mm/min] to F1500 [mm/min] at which power consumption is minimized.

The digital device 20 transmits the modified machining program to the machine tool 10.

Thus, the digital device 20 can reproduce accurate electric power simulation by inputting the power waveform measured in the machine tool 10 to the digital device 20, whereas it is difficult for conventional simulators to reproduce actual electric power amounts only based on theoretical models.

(E) Regarding the Case Where the Occurrence of an Overheat Alarm is Reproduced Using the Motor Temperature of the Machine Tool 10

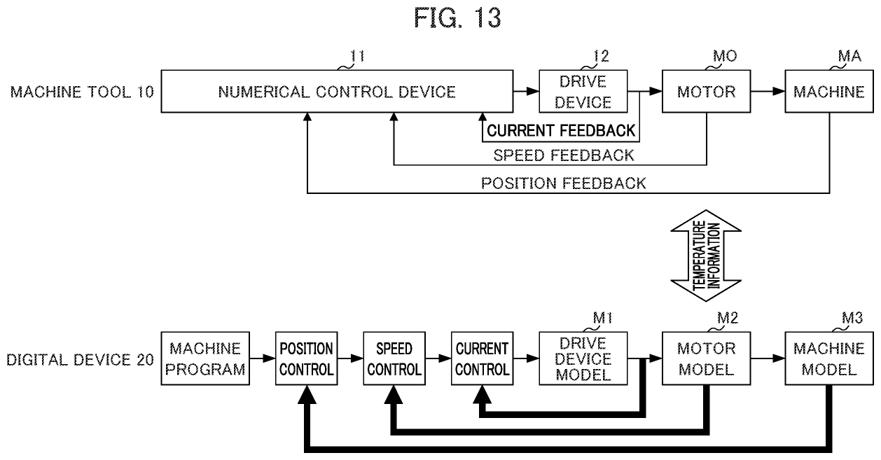

FIG. 13 shows an operation example of the industrial machine control system 1 when the occurrence of an overheat alarm is reproduced using the motor temperature of the machine tool 10. Note that elements having the same functions as those of the elements in FIG. 4 are denoted by the same reference numerals, and detailed descriptions thereof are omitted.

As in the case of FIG. 4, the numerical control device 11 executes the machining program to acquire the position feedback, speed feedback, and current feedback as the operation state data R along with the position command, speed command, and current command. Furthermore, the numerical control device 11 acquires, as the operation state data R, information on how long the motor MO is rotated, which indicates the relationship between the rotation speed (or current) of the motor MO, the rotation time of the motor MO, and the motor temperature measured by a temperature sensor (not shown) provided in the motor MO. The digital device 20 acquires the operation state data R in the numerical control device 11 via the information collecting device 14, and simulates the occurrence of an overheat alarm by correcting the motor temperature in the motor model M2 using the relationship between the rotation speed (or current) of the motor MO measured by the numerical control device 11, the operation time of the motor MO, and the motor temperature of the motor MO.

Specifically, the numerical control device 11 measures the relationship between the rotation time and the motor temperature for each rotation speed (or current) by executing the machining program for testing in which the rotation speed (or current) is changed.

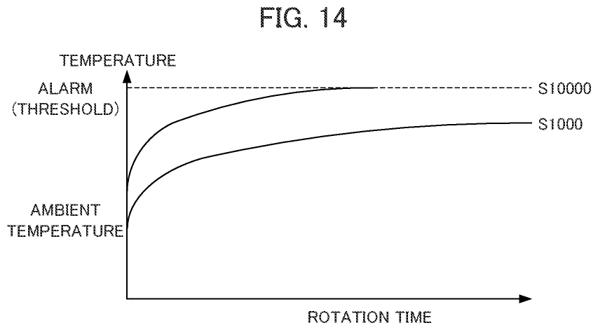

FIG. 14 shows an example of the relationship between the rotation time and the motor temperature for each rotation speed (or current). In FIG. 14, “S1000” and “S10000” are commanded as the rotation speeds in the machining program, and the relationship between the rotation time and the motor temperature is measured for each rotation speed. In FIG. 14, the threshold for the overheat alarm is set in advance.

The information collecting device 14 outputs the operation state data R including the relationship (function) between the rotation time and the temperature in FIG. 14 along with the rotation speed (or current) of the motor MO and the rotation time of the motor MO acquired by the numerical control device 11, to the digital device 20.

The simulation execution unit 220 of the digital device 20 compares the motor temperature calculated from the relationship (function) between the rotation time and the temperature included in the acquired operation state data R with the motor temperature calculated from the motor model M2, and inputs the difference, thereby correcting the motor temperature. Thus, the simulation execution unit 220 can accurately simulate (emulate) the occurrence of the overheat alarm.

In other words, the digital device 20 can reproduce accurate temperature simulation by inputting the difference between the motor temperature measured in the machine tool 10 and the motor temperature of the digital device 20 to the digital device 20, and can perform preventive maintenance of the overheat alarm of the motor MO, whereas it is difficult for conventional simulators to reproduce actual motor temperatures only based on theoretical models.

The numerical control device 11 acquires information on how long the motor MO is rotated including the relationship (function) between the rotation time and the temperature in FIG. 14 along with the rotation speed (or current) of the motor MO and the rotation time of the motor MO, and the information collecting device 14 outputs the operation state data R including the information to the digital device 20, but the present invention is not limited thereto.

For example, the numerical control device 11 may only measure the motor temperature TO of the motor MO at the time of stopping and the motor temperature Tr1 and the cutting speed F1 of the motor MO at the time of cutting. The information collecting device 14 outputs the motor temperature T0 of the motor MO at the time of stopping and the motor temperature Tr1 and the cutting speed F1 of the motor MO at the time of cutting, which are measured by the numerical control device 11, to the digital device 20. Since the theoretical heat generation of the motor can be calculated from the current value of the motor and the winding resistance, the theoretical temperature value of the motor MO with respect to the motor temperature T0 at the time of stopping is “0” degrees. The theoretical temperature value of the motor MO with respect to the motor temperature Tr1 at the time of cutting is calculated as Td1.

The simulation execution unit 220 of the digital device 20 calculates the difference (Tr1−Td1−T0) (=ΔT) between the measured motor temperature and the theoretical temperature value Td1.

The simulation execution unit 220 linearly proportionally distributes ΔT from the speed 0 to the cutting speed F1, and calculates the temperature T at the actual speed F as the theoretical temperature value Td1+T0+(ΔT/cutting speed F1)×the actual speed F.

The motor temperature T0 includes the ambient temperature, and the difference ΔT includes the heat generated by the load due to mechanical friction and tool wear, as well as the heat generated by individual product differences due to variations in physical constants (resistance values), allowing the digital device 20 to perform simulation more accurately and simulate (emulate) the occurrence of the overheat alarm accurately.

As described above, the industrial machine control system 1 according to the embodiment can reproduce the state of the machine tool 10 more accurately than conventional simulators by inputting the operation state data indicating the behavior of the machine tool 10 to the digital device 20.

In addition, the industrial machine control system 1 performs simulation one or more times using highly accurate information reproduced by the digital device 20, whereby the setting values and the control programs related to the control existing in the machine tool 10 can be modified in a short time with high accuracy.

Although one embodiment has been described above, the industrial machine control system 1 is not limited to the above embodiment, and includes modifications, improvements, and the like to the extent that the object can be achieved.

### <Modification 1>

In one embodiment, the machine tool 10 includes the numerical control device 11, the drive device 12, the peripheral device 13, and the information collecting device 14, but the present invention is not limited thereto. For example, each of the numerical control device 11, the drive device 12, the peripheral device 13, and the information collecting device 14 may be a device different from the machine tool 10.

The numerical control device 11 may include the digital device 20.

### <Modification 2>

For example, in one embodiment, the digital device 20 performs preventive maintenance of the overheat alarm of the motor MO by comparing the measured motor temperature of the motor MO with the motor temperature of the simulated motor model M2 and inputting the difference to the digital device 20, but the present invention is not limited thereto.

For example, the operation state data R may include operating information such as operating time, cutting time, and spindle rotation speed of components such as a ball screw, a bearing, and a spindle included in the machine tool 10. The digital device 20 may simulate the timing of replacement of the components such as the ball screw by comparing the operating information included in the acquired operation state data R with the operating information obtained by simulation and inputting the difference to the digital device 20.

Each function included in the industrial machine control system 1 according to one embodiment can be implemented by hardware, software, or a combination thereof. Here, “implemented by software” means that it is implemented by a computer reading and executing a program.

The program may be stored and provided to the computer using various types of non-transitory computer readable media. The non-transitory computer readable media include various types of tangible storage media. Examples of the non-transitory computer readable media include magnetic recording media (e.g., flexible disks, magnetic tapes, and hard disk drives), magneto-optical recording media (e.g., magneto-optical disks), CD-ROMs (read only memories), CD-Rs, CD-R/Ws, and semiconductor memories (e.g., mask ROMs, PROMS (programmable ROMs), EPROMs (erasable PROMs), flash ROMs, and RAMs). The program may also be provided to the computer by various types of transitory computer readable media. Examples of the transitory computer readable media include electrical signals, optical signals, and electromagnetic waves. The transitory computer readable media can provide the program to the computer via wired communication paths such as electric wires and optical fibers, or wireless communication paths.

Note that the step of describing the program to be recorded in the recording medium includes not only processing performed in time series along the order but also processing performed in parallel or individually, which is not necessarily performed in time series.

In other words, the industrial machine control system of the present disclosure can take various embodiments having the following configurations.

(1) An industrial machine control system 1 of the present disclosure includes a real device including a numerical control device 11 configured to control a machine tool 10 and a digital device 20 configured to simulate the real device with software. The digital device 20 includes an input unit 21 for inputting operation state data R acquired in the real device to the digital device 20. The digital device 20 simulates the real device with the operation state data R input to the input unit 21.

According to the industrial machine control system 1, the state of the real device can be reproduced more accurately by using the operation state data indicating the behavior of the real device.

(2) In the industrial machine control system 1 disclosed in (1), the operation state data may include difference data between the operation state data R of the real device and operation state data D of the digital device 20.

Thus, the industrial machine control system 1 can perform more accurate reproduction.

(3) In the industrial machine control system 1 disclosed in (1), the operation state data may include at least one of the operation state data R measured from the real device, the operation state data R detected from the real device, or a control amount created in the real device.

Thus, the industrial machine control system 1 can achieve the same effect as in (2).

(4) In the industrial machine control system 1 disclosed in (2), the digital device 20 may modify a program executed in the real device or a parameter set in the real device by inputting the difference data.

Thus, the industrial machine control system 1 can improve the design efficiency in the design (application development) of the industrial machine and improve the productivity in the operation (machining) of the industrial machine.

(5) In the industrial machine control system 1 disclosed in any one of (1) to (4), the operation state data R may include at least one of a signal processing speed, a feedback amount, CPU performance, power consumption, or a motor temperature.

Thus, the industrial machine control system 1 can accurately reproduce the real device according to the situation.

(6) In the industrial machine control system 1 disclosed in (5), when the operation state data R is the signal processing speed, the digital device 20 may reproduce operation of the machine tool 10 using processing time of each instruction included in a program.

Thus, the industrial machine control system 1 can execute the program at the same timing as the machine tool 10.

(7) In the industrial machine control system 1 disclosed in (5), when the operation state data R is the feedback amount, the digital device 20 may reproduce operation of the machine tool 10 using at least one of feedback amount of position feedback, feedback amount of speed feedback, or feedback amount of current feedback.

Thus, the industrial machine control system 1 can accurately match the actual behavior of the motor and machine of the machine tool 10.

(8) In the industrial machine control system 1 disclosed in (5), when the operation state data R is the CPU performance, the digital device 20 may modify a program using a limit value of a command processing speed of the numerical control device 11 and information indicating a relationship between a block length of the program and the command processing speed.

Thus, the industrial machine control system 1 can optimize the program in consideration of the actual processing capability of the numerical control device 11.

(9) In the industrial machine control system 1 disclosed in (5), when the operation state data R is the power consumption, the digital device 20 may modify a program using a relationship between a feed speed of a motor MO or a spindle rotation speed included in the machine tool 10 and the power consumption at the feed speed or the spindle rotation speed.

Thus, the industrial machine control system 1 can accurately reproduce the power consumption of the machine tool 10.

(10) In the industrial machine control system 1 disclosed in (5), when the operation state data R is the motor temperature, the digital device 20 may reproduce occurrence of an alarm related to a motor MO included in the machine tool 10 using information indicating a relationship between a rotation speed or a current of the motor MO, a rotation time of the motor MO, and a motor temperature of the motor MO.

Thus, the industrial machine control system 1 can perform preventive maintenance of the alarm related to the motor MO.

(11) In the industrial machine control system 1 disclosed in (8) or (9), the digital device 20 may transmit the modified program to the machine tool 10.

Thus, the industrial machine control system 1 can optimize the program to be executed by the machine tool 10.

### EXPLANATION OF REFERENCE NUMERALS

1 Industrial machine control system

10 Machine tool

11 Numerical control device

12 Drive device

13 Peripheral device

14 Information collecting device

20 Digital device

21 Input unit

22 Control unit

220 Simulation execution unit

221 Operation state data difference generation unit

23 Storage unit

R operation state data

231 Operation state difference data

D Operation state data

1. An industrial machine control system comprising a real device comprising a control device configured to control an industrial machine and a digital device configured to simulate the real device with software,
the digital device comprising an input unit for inputting operation state data acquired in the real device to the digital device,
the digital device simulating the real device with the operation state data input to the input unit.

2. The industrial machine control system according to claim 1, wherein the operation state data includes difference data between the operation state data of the real device and operation state data of the digital device.

3. The industrial machine control system according to claim 1, wherein the operation state data includes at least one of the operation state data measured from the real device, the operation state data detected from the real device, or a control amount created in the real device.

4. The industrial machine control system according to claim 2, wherein the digital device modifies a program executed in the real device or a parameter set in the real device by inputting the difference data.

5. The industrial machine control system according to claim 1, wherein the operation state data includes at least one of a signal processing speed, a feedback amount, CPU performance, power consumption, or a motor temperature.

6. The industrial machine control system according to claim 5, wherein when the operation state data is the signal processing speed, the digital device reproduces operation of the real device using processing time of each instruction included in a program.

7. The industrial machine control system according to claim 5, wherein when the operation state data is the feedback amount, the digital device reproduces operation of the real device using at least one of feedback amount of position feedback, feedback amount of speed feedback, or feedback amount of current feedback.

8. The industrial machine control system according to claim 5, wherein when the operation state data is the CPU performance, the digital device modifies a program using a limit value of a command processing speed of the control device and information indicating a relationship between a block length of the program and the command processing speed.

9. The industrial machine control system according to claim 5, wherein when the operation state data is the power consumption, the digital device modifies a program using a relationship between a feed speed of a motor or a spindle rotation speed included in the real device and the power consumption at the feed speed or the spindle rotation speed.

10. The industrial machine control system according to claim 5, wherein when the operation state data is the motor temperature, the digital device reproduces occurrence of an alarm related to a motor included in the real device using information indicating a relationship between a rotation speed or a current of the motor, a rotation time of the motor, and a motor temperature of the motor.

11. The industrial machine control system according to claim 8, wherein the digital device transmits the modified program to the real device.
